(19) United States
(12) Patent Application Publication
(10) Pub. No.: US 2012/0196183 A1
(43) Pub. Date: Aug. 2, 2012

(54) POSITIVE ELECTRODE FOR NONAQUEOUS ELECTROLYTE SECONDARY BATTERY, PRODUCTION METHOD THEREOF AND NONAQUEOUS ELECTROLYTE SECONDARY BATTERY

(75) Inventors: Takanobu Chiga, Kobe-city (JP); Naoki Imachi, Kobe-city (JP); Satoshi Takatsuka, Kobe-city (JP)

(73) Assignee: SANYO ELECTRIC CO., LTD., Moriguchi-city (JP)

(21) Appl. No.: 13/359,318

(22) Filed: Jan. 26, 2012

(30) Foreign Application Priority Data
Jan. 28, 2011 (JP) 2011-016681
Jul. 27, 2011 (JP) 2011-164176

(51) Int. Cl. H01M 4/62; H01M 4/04; H01M 4/26

(52) U.S. Cl. 429/215; 427/58

(57) ABSTRACT

The object is to obtain a positive electrode for a nonaqueous electrolyte secondary battery capable of suppressing gas generation even if continuous charging is performed at a high temperature. Provided is a positive electrode for a nonaqueous electrolyte secondary battery comprising a positive-electrode active material, wherein the positive-electrode active material has a surface-treated layer with a silane coupling agent represented by the following general formula (1):

X1-Y—X2 (1)

wherein Y is an alkylene group having 10 or less carbon atoms, and X1 and X2 are each represented by the general formula (2):

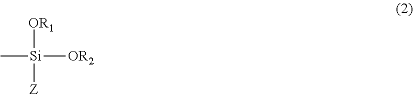

wherein Z is an alkyl group having 10 or less carbon atoms or OR₃, and R₁, R₂ and R₃, are each an alkyl group having 5 or less carbon atoms.

### BACKGROUND OF THE INVENTION

1. Field of the Invention

The present invention relates to a positive electrode for a nonaqueous electrolyte secondary battery, a production method thereof, and a nonaqueous electrolyte secondary battery.

2. Description of the Related Art

Recently, miniaturization and weight saving of portable information terminal devices such as cell phones, laptop computers, and PDAs have been rapidly advanced, and it is required to have a higher capacity for batteries used for supplying a drive power to the devices. In order to satisfy such a requirement, nonaqueous electrolyte secondary batteries using nonaqueous electrolyte solution in which lithium ions are moved between a positive electrode and a negative electrode to charge or discharge the batteries are widely utilized as a new-type secondary battery having a high output and a high energy density.

In such a nonaqueous electrolyte secondary battery, lithium cobaltate (LiCoO₂), spinel lithium manganate (LiMn₂O₄), lithium composite oxides of cobalt-nickel-manganese, and lithium composite oxides of aluminum-nickel-cobalt are usually used as a positive-electrode active material. On the other hand, carbon materials such as graphite and materials capable of alloying with lithium such as Si and Sn are used as a negative-electrode active material.

Recently, however, richness of functions of portable information terminal devices such as video playback and game functions has been advanced, and therefore electricity consumption tends to further increase and it is required to make the capacity higher.

A method in which a charging voltage is set at a high level to improve a utilization rate of a positive-electrode active material can be considered for making the capacity of the nonaqueous electrolyte secondary battery higher. For example, when a generally-used lithium cobaltate is charged until a voltage reaches 4.3 V based on metal Li (when a counter electrode is a graphite negative electrode, the voltage is 4.2 V), a capacity thereof is about 160 mAh/g, but when it is charged until a voltage reaches 4.5 V based on metal Li (when a counter electrode is a graphite negative electrode, the voltage is 4.4 V), the capacity can be increased up to about 190 mAh/g.

When a battery having a positive-electrode active material such as lithium cobaltate is charged to a high voltage, however, easy decomposition of electrolyte solution becomes problem. In particular, when continuous charging is performed at a high temperature, the electrolyte solution is decomposed and gas is generated, thus resulting in occurrence of problems such as swelling of a battery and an increased internal pressure of the battery.

In order to suppress decomposition of electrolyte solution, a surface treatment of a positive-electrode active material with a silane coupling agent has been hitherto proposed.

For example, JP-A No. 8-111243 and JP-A No. 11-354104 propose that a positive electrode or a negative electrode is treated with a silane coupling agent to form a stable film on a surface of active material particles, thereby reducing an irreversible capacity or improving cycling characteristics.

JP-A No.2002-367610 proposes that a positive-electrode active material is coated with a silane coupling agent to improve cycling characteristics and storage characteristics.

In addition, JP-A No. 2005-63953, JP-A No. 2007-18874 and JP-A No. 2008-235090 propose that a lithium nickel composite oxide mainly including Ni is treated with a coupling agent, whereby cycling characteristics and storage characteristics can be improved.

### SUMMARY OF THE INVENTION

All of the coupling agents, however, could insufficiently suppress gas generation when the charging is continuously performed at a high temperature.

In order to satisfy the recent need for increasing the capacity, suppression of a side reaction between electrolyte solution and a positive-electrode active material and suppression of increase in a thickness of a battery are necessary even if a battery is continuously charged at a high temperature, and therefore coupling agents different from conventional ones are required.

The object of the present invention to provide a positive electrode for a nonaqueous electrolyte secondary battery capable of suppressing gas generation even if continuous charging is performed at a high temperature, a production method thereof, and a nonaqueous electrolyte secondary battery.

The positive electrode for a nonaqueous electrolyte secondary battery of the present invention is characterized by including a positive-electrode active material, wherein the positive-electrode active material has a surface-treated layer with a silane coupling agent represented by the following general formula (1):

X1-Y—X2 (1)

wherein Y is an alkylene group having 10 or less carbon atoms, and X1 and X2 are each represented by the following general formula (2):

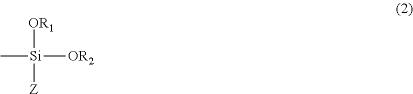

wherein Z is an alkyl group having 10 or less carbon atoms or OR₃, and R₁, R₂, and R₃ are each an alkyl group having 5 or less carbon atoms.

The production method of a positive electrode for a nonaqueous electrolyte secondary battery is a method capable of producing the positive electrode for a nonaqueous electrolyte secondary battery of the present invention, including addition of a silane coupling agent to positive-electrode active material slurry.

That is, the method for producing the positive electrode for a nonaqueous electrolyte secondary battery includes a step of kneading a mixture including a positive-electrode active material and the silane coupling agent in a solvent to prepare positive-electrode active material slurry; and a step of coating a surface of a positive electrode collector with the positive-electrode active material slurry to form a positive-electrode active material layer on the positive electrode collector.

When the positive-electrode active material having the surface-treated layer with the silane coupling agent represented by the general formula (1), according to the present invention, is used, the gas generation can be suppressed even if continuous charging is performed at a high temperature.

According to the present invention, therefore, the gas generation can be suppressed even if the continuous charging is performed at a high temperature, and high reliability can be obtained.

### BRIEF DESCRIPTION OF THE DRAWINGS

FIG. 1 is a schematic view showing a bonding state of a silane coupling agent on a surface-treated layer formed by using the silane coupling agent according to the invention; and

FIG. 2 is a schematic view showing a bonding state of a conventional silane coupling agent on a surface-treated layer formed by using the conventional silane coupling agent.

### DETAILED DESCRIPTION OF THE PREFERRED EXAMPLES

Y in the general formula (1) is an alkylene group having 10 or less carbon atoms, more preferably an alkylene group having 2 to 6 carbon atoms. The alkylene group may be linear or branched. However, because the branched alkylene groups are easily oxidized, the linear alkylene groups are preferable. At least a part of hydrogen atoms in the alkylene group may be substituted by fluorine atoms. Fluorination of the alkylene group can improve resistance to oxidation.

X1 and X2 in the general formula (1) are each an alkoxysilyl group represented by the general formula (2), which may be a dialkoxysilyl group or a trialkoxysilyl group. Z in the general formula (2) is, accordingly, an alkyl group having 10 or less carbon atoms or OR₃. R₁, R₂, and R₃ are each an alkyl group having 5 or less carbon atoms, more preferably an alkyl group having 1 or 2 carbon atoms. That is, methoxysilyl group and ethoxysilyl group are preferable.

When Z is the alkyl group having 10 or less carbon atoms, alkyl groups having 2 to 6 carbon atoms are more preferable.

The lower limit of the content of the silane coupling agent in the positive-electrode active material is preferably 0.005% by mass or more based on the positive-electrode active material, more preferably 0.01% by mass or more, further more preferably 0.02% by mass or more. The upper limit of the content of the silane coupling agent in the positive-electrode active material is 5% by mass or less based on the positive-electrode active material, more preferably 2% by mass or less, further more preferably 1% by mass or less. When the content of the silane coupling agent is too small, the positive-electrode active material cannot be sufficiently covered with the surface-treated layer with the silane coupling agent, and there are times in which the effect of suppressing the gas generation may not be sufficiently obtained. On the other hand, when the content of the silane coupling agent is too large, the surface of the positive-electrode active material is covered with an excess amount of the silane coupling agent, and load characteristics may be sometimes decreased. The phrase “0.01% by mass based on the positive-electrode active material” refers to 0.01 part by mass based on 100 parts by mass of the positive-electrode active material.

Methods for forming the surface-treated layer with the silane coupling agent on the surface of the positive-electrode active material are not particularly limited. For example, the positive-electrode active material is mechanically mixed with the silane coupling agent and the mixture is stirred, whereby the surface-treated layer can be formed on the surface of the positive-electrode active material. In addition, after the positive-electrode active material is immersed in a solution of the silane coupling agent, the resulting material is taken out therefrom and it is dried, whereby the surface-treated layer may be formed on the surface of the positive-electrode active material.

The surface-treated layer can be also formed on the surface of the positive-electrode active material by adding the silane coupling agent to slurry including the positive-electrode active material and a binding agent, because of a high reactivity of the silane coupling agent used in the present invention. The method of directly adding the silane coupling agent to the positive-electrode active material slurry is economically excellent, because the number of steps is not increased when the positive electrode is produced. That is, it is not necessary to form the surface-treated layer with the silane coupling agent on the surface of the positive-electrode active material prior to the preparation of the positive-electrode active material slurry.

Any material may be used as the positive-electrode active material without particular limitations, so long as it can absorb and release lithium, and is electropositive. For example, lithium-transition metal composite oxides having a layered structure, a spinel structure, or an olivine structure can be used. The lithium-transition metal composite oxides having the layered structure are preferable in terms of the high energy density as the positive-electrode active material. Examples of such a lithium transition metal composite oxide may include composite oxides of lithium-nickel, composite oxides of lithium-nickel-cobalt, composite oxides of lithium-nickel-cobalt-aluminum, composite oxides of lithium-nickel-cobalt-manganese, composite oxides of lithium-cobalt, and the like.

Lithium cobaltate in which Al or Mg is solidified inside the crystal and Zr adheres to the particle surface is preferable in terms of a stability of crystal structure.

For decreasing the amount of expensive cobalt used, lithium-transition metals composite oxides having a ratio of nickel of 40% or more in transition metals included in the positive-electrode active material are preferable, and lithium-transition metals composite oxides including lithium, nickel, cobalt, and aluminum are particularly preferable, in terms of the stability of crystal structure.

Examples of the binding agent used in the positive electrode may include fluorine-containing resins including vinylidene fluoride units such as poly(vinylidene fluoride) (PVDF), modified PVDF. Examples of the solvent used for preparing the positive electrode slurry may include N-methyl-2-pyrrolidone (NMP), and the like.

Any material can be used without particular limitations as the negative-electrode active material, so long as it can absorb and release lithium. Examples of the negative-electrode active material may include carbon materials such as graphite and coke, metal oxides such as tin oxide, metals capable of alloying with lithium and absorbing lithium, such as silicon and tin, metal lithium, and the like. Of these, the graphite carbon materials are preferable because they have a small volume variation caused by absorption or release of lithium, and good reversibility.

As the solvent for the nonaqueous electrolyte, for example, solvents conventionally used in nonaqueous electrolyte secondary batteries can be used. Of these, mixed solvents of a cyclic carbonate and a linear carbonate are particularly preferably used. Specifically, a mixed ratio of the cyclic carbonate to the linear carbonate (the cyclic carbonate:the linear carbonate) is preferably within a range of 1:9 to 5:5 in volume.

Examples of the cyclic carbonate may include ethylene carbonate, fluoroethylene carbonate, propylene carbonate, butylene carbonate, vinylene carbonate, vinylethylene carbonate, and the like. Examples of the linear carbonate may include dimethyl carbonate, methyl ethyl carbonate, diethyl carbonate, and the like.

Examples of the solute in the nonaqueous electrolyte may include LiPF₆, LiBF₄, LiCF₃SO₃, LiN(SO₂F)₂, LiN(SO₂CF₃)₂. LiN(SO₂C₂F₅)₂, LiC(SO₂CF₃)₃, LiC(SO₂C₂F₅)₃, LiClO₄, and mixtures thereof.

Gel polymer electrolyte in which polymer such as polyethylene oxide or polyacrylonitrile is impregnated with electrolyte solution may be used as the electrolyte.

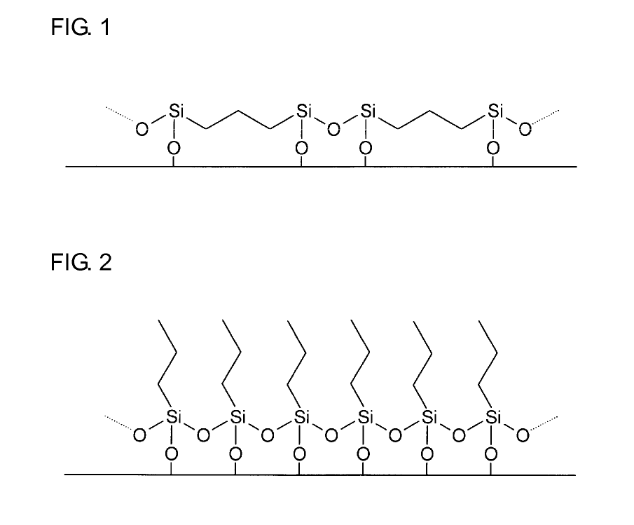

FIG. 1 is a schematic view showing a bonding state of the silane coupling agent in the surface-treated layer with the silane coupling agent according to the present invention.

The silane coupling agent in the present invention has alkoxysilyl groups at both ends thereof. It would appear that the alkoxy group included in the alkoxysilyl group is formed into a silanol (Si—OH) by hydrolysis, and a condensation reaction between the silanol groups and a condensation reaction between the silanol group and a hydroxyl group on the surface of the positive-electrode active material lead to formation of a film, which is a surface-treated layer having a structure shown in FIG. 1, on the surface of the positive-electrode active material.

As shown in FIG. 1, on the surface-treated layer which is formed by using the silane coupling agent according to the present invention, hydrocarbon chains having a low affinity with the electrolyte solution can be located in the vicinity of the active material surface. This structure can prevent a side reaction of the surface of the positive-electrode active material with the electrolyte solution, and the gas generation can be reduced.

The film of the surface-treated layer includes the hydrocarbon chain in an inorganic polymer whose backbone is siloxane (Si—O), and therefore it would appear that the film is more flexible compared to a film composed of siloxane alone. Accordingly, the film removal caused by the volume variation of active material which occurs when the battery is discharged or charged can be prevented.

FIG. 2 is a schematic view showing a bonding state of a conventional silane coupling agent in a surface-treated layer formed by using the conventional silane coupling agent. The conventional silane coupling agent has one alkoxysilyl group in its molecule. It would appear, accordingly, the film is composed of the silane coupling agent in the bonding state as shown in FIG. 2.

As shown in FIG. 2, hydrocarbon chains are oriented in a vertical direction to the surface of the active material, and an inorganic polymer whose backbone is siloxane is formed under the layer composed of the hydrocarbon. As the inorganic polymer is hard and has low flexibitily, it would appear that the film cannot reduce the volume variation of the active material, and has a structure which is easily removed from the surface of the active material. When the conventional silane coupling agent is used, accordingly, it would appear that the side reaction between the surface of the positive-electrode active material and the electrolyte solution cannot be sufficiently prevented, thus resulting in the gas formation.

As described above, when the surface-treated layer is formed on the surface of the positive-electrode active material using the silane coupling agent according to the present invention, the gas formation might be suppressed even if the continuous charging is performed at a high temperature.

### EXAMPLE

The present invention will be explained in more detail by means of Examples, but the invention is not limited to Examples described below, and can be carried out by arbitrarily modifying it without departing from the gist of the invention.

### Examples 1 to 3 and Comparative Examples 1 to 5

### Example 1

[Production of Positive Electrode]

Lithium cobaltate (LiCoO₂) in which 1.0% by mole of aluminum (Al) and 1.0% by mole of magnesium (Mg) were solidified and to which 0.05% by mole of zirconium (Zr) adhered was used as the positive-electrode active material. The positive-electrode active material, acetylene black (AB) as a conductive agent, and poly(vinylidene fluoride) as a binding agent were kneaded together with N-methyl-2-pyrrolidone (NMP) as a solvent. The positive-electrode active material, the conductive agent, and the binding agent were mixed in a mass ratio of 95:2.5:2.5. In addition, the silane coupling agent was added to the mixture in a content of 1% by mass based on the positive-electrode active material, and the resulting mixture was stirred to produce positive-electrode active material slurry. 1,2-Bis(trimethoxysilyl)ethane, as shown in Table 1, was used as a silane coupling agent.

After an aluminum foil, which was a positive electrode collector, was coated on both sides thereof with the thus produced slurry and dried, it was rolled to obtain a positive electrode. The positive electrode had a packing density of 3.8 g/cm³.

[Production of Negative Electrode]

Graphite as a negative-electrode active material, styrene-butadiene rubber as a binding agent, carboxymethyl cellulose as a thickener were mixed in a mass ratio of 98:1:1, and the mixture was kneaded in an aqueous solution to produce negative-electrode active material slurry. After a copper foil, which was a negative electrode collector, was coated on both sides thereof with the negative-electrode active material slurry and dried, it was rolled to obtain a negative electrode.

[Production of Nonaqueous Electrolyte Solution]

Ethylene carbonate (EC) and diethyl carbonate (DEC) were mixed in a volume ratio of 3:7, and 1.0 mole/liter of LiPF₆ was added to this mixed solvent. Vinylene carbonate as an addictive was added to the thus obtained solution in an amount of 1 part by mass based on 100 parts by mass of the solution to produce nonaqueous electrolyte solution.

[Assembly of Battery]

Lead terminals were attached to the positive electrode and the negative electrode, and they were faced to each other through a separator. The faced electrodes were spirally wound, which were pressed and crushed into a flat shape to obtain an electrode assembly. After the electrode assembly was put in a battery external member made of an aluminum laminate, the nonaqueous electrolyte solution was injected thereto, and then the external member was sealed to produce a battery for test.

This battery had a design capacity of 750 mAh, and its size was 3.6 mm×35 mm×62 mm. The design capacity of the battery was designed based on a charge final voltage of up to 4.4 V.

### Example 2

A battery for test was produced in the same manner as in Example 1 except that 1,2-bis(triethoxysilyl)ethane was used as the silane coupling agent.

### Example 3

A battery for test was produced in the same manner as in Example 1 except that 1,2-bis(trimethoxysilyl)hexane was used as the silane coupling agent.

### Comparative Example 1

A battery for test was produced in the same manner as in Example 1 except that the silane coupling agent was not added to the positive-electrode active material slurry.

### Comparative Example 2

A battery for test was produced in the same manner as in Example 1 except that the silane coupling agent was not added to the positive-electrode active material slurry, but was added to the electrolyte solution. The silane coupling agent was added in an amount of 1.0% by mass based on the positive-electrode active material.

### Comparative Example 3

A battery for test was produced in the same manner as in Example 1 except that trimethoxysilylethane was used as the silane coupling agent.

### Comparative Example 4

A battery for test was produced in the same manner as in Example 1 except that triethoxysilylethane was used as the silane coupling agent.

### Comparative Example 5

A battery for test was produced in the same manner as in Example 1 except that trimethoxysilylhexane was used as the silane coupling agent.

The names and the structures of the silane coupling agents used in Examples 1 to 3 and Comparative Examples 2 to 5 are collectively shown in Table 1.

| | Silane coupling agent | Structure |
|---|---|---|
| Example 1 Comparative Example 2 | 1,2-bis(trimethoxysilyl)ethane | 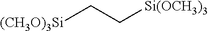 |
| Example 2 | 1,2-bis(triethoxysilyl)ethane | 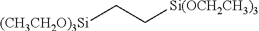 |
| Example 3 | 1,2-bis(trimethoxysilyl)hexane | 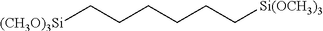 |
| Comparative Example 3 | Trimethoxysilylethane | 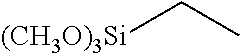 |
| Comparative Example 4 | Triethoxysilylethane | 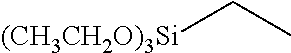 |
| Comparative Example 5 | Trimethoxysilylhexane | 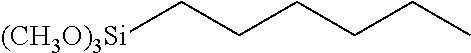 |

[Conditions of Charge-Discharge Cycle Test]

Charging and discharging were performed in the following conditions, and a charge-discharge cycle test described below was performed.

Charging Condition

Charging was performed at a constant current of 1 It (750 mA) until a voltage reached 4.4 V, and after that charging was continued at the constant voltage until a current reached 37.5 mA.

Discharging Condition

Discharging was performed at a constant current of 1 It (750 mA) until a voltage reached 2.75 V.

Pause

There was a 10-minute pause time between the charging and the discharging.

[Initial Charge and Discharge Efficiency]

The charge-discharge cycle test was performed under the charging and discharging conditions described above, and an initial charge and discharge efficiency was measured. The results are shown in Table 2.

[Measurement of Increase Battery Thickness by Continuous Charging at 60° C.]

The charge-discharge cycle test was performed once under the charging and discharging conditions described above, and after that, charging was performed at a constant voltage of 4.4 V for 65 hours in a thermostat chamber at a temperature of 60° C. The increase in the battery thickness before and after the continuous charging at 60° C. was measured, and the measurement results are shown in Table 2 as the increase in the thickness.

TABLE 2

| | | | Addition | Initial charge and | Increase |
|---|---|---|---|---|---|
| | | Object of | amount | discharge efficiency | in thickness |
| | Silane coupling agent | addition | (% by mass) | (%) | (mm) |
| Example 1 | 1,2-bis(trimethoxysilyl)ethane | Positive | 1.0 | 89.3 | 0.33 |
| | | electrode | | | |
| Example 2 | 1,2-bis(triethoxysilyl)ethane | Positive | 1.0 | 89.7 | 0.56 |
| | | electrode | | | |
| Example 3 | 1,2-bis(trimethoxysilyl)hexane | Positive | 1.0 | 89.6 | 0.46 |
| | | electrode | | | |
| Comparative Example 1 | — | — | 0.0 | 89.5 | 0.79 |
| Comparative Example 2 | 1,2-bis(trimethoxysilyl)ethane | Electrolyte | 1.0 | 89.0 | 3.83 |
| | | solution | | | |
| Comparative Example 3 | Trimethoxysilylethane | Positive | 1.0 | 89.5 | 0.99 |
| | | electrode | | | |
| Comparative Example 4 | Triethoxysilylethane | Positive | 1.0 | 89.3 | 0.88 |
| | | electrode | | | |
| Comparative Example 5 | Trimethoxysilylhexane | Positive | 1.0 | 89.7 | 1.14 |
| | | electrode | | | |

As shown in Table 2, the increases in the battery thickness in Examples 1 to 3 in which the coupling agents according to the present invention were used were smaller than that in Comparative Example 1 in which no silane coupling agent was added, and it is seen that the gas generation could be suppressed during the continuous charging at a high temperature in Examples 1 to 3.

In addition, it is seen that in Comparative Examples 3 to 5 in which the conventional silane coupling agents were used, the gas generation was less suppressed during the continuous charging at a high temperature compared to that in Comparative Example 1 in which no silane coupling agent was added; rather, the gas generation was increased. It is seen, accordingly, that when the conventional silane coupling agents were used, the side reaction between the surface of the positive-electrode active material and the electrolyte solution could not be sufficiently suppressed.

In Comparative Example 2 in which silane coupling agent was added to the electrolyte solution, the increase in the battery thickness was remarkably larger than those in other Comparative Examples and the amount of gas generated was remarkably increased. This can be thought to be because the silane coupling agent added might possibly act on the negative electrode and the silane coupling agent was easily reduced, whereby the bad influences were generated.

The difference in the initial charge and discharge efficiency was scarcely observed between Examples 1 to 3 in which the silane coupling agents were added and Comparative Example 1 in which no silane coupling agent was added. When the surface of the positive-electrode active material was treated with the silane coupling agent, bad influences on the initial charge and discharge efficiency were not confirmed.

As described above, when the silane coupling agent is used according to the present invention, the side reaction between the positive-electrode active material and the electrolyte solution can be suppressed during the continuous charging at a high temperature, and the gas generation can be also suppressed. In addition, such effects apparently cannot be obtained when the conventional silane coupling agents having the alkoxysilyl group only at one end thereof is used.

[Measurement of Residual Capacity Rate]

Residual capacity rates were measured for the batteries of Examples 1 to 3 and Comparative Examples 1 and 2 before and after the continuous charging at 60° C.

In the test described above in which the continuous charging was performed at 60° C., a discharge capacity Q₀ was measured before the continuous charging in the charge-discharge cycle test. After the continuous charging at 60° C., the battery was cooled to room temperature and was discharged at room temperature, and then a discharge capacity Q₁ was measured. A residual capacity rate was calculate using the following formula from the discharge capacity Q₀ before the continuous charging at 60° C. and the first discharge capacity Q₁ after the continuous charging.

Residual Capacity Rate (%)=[the first discharge capacity (Q₁) after the continuous charging test/the discharge capacity (Q₀) before the continuous charging test]×100

The residual capacity rates in Examples 1 to 3 and Comparative Examples 1 and 2 are shown in Table 3.

TABLE 3

| | | | Addition | |
|---|---|---|---|---|
| | | Object of | amount | Residual Capacity |
| | Silane coupling agent | addition | (% by mass) | Rate |
| Example 1 | 1,2-bis(trimethoxysilyl)ethane | Positive | 1.0 | 81.8% |
| | | electrode | | |
| Example 2 | 1,2-bis(triethoxysilyl)ethane | Positive | 1.0 | 77.9% |
| | | electrode | | |
| Example 3 | 1,2-bis(trimethoxysilyl)hexane | Positive | 1.0 | 78.6% |
| | | electrode | | |
| Comparative Example 1 | — | — | 0.0 | 76.7% |
| Comparative Example 2 | 1,2-bis(trimethoxysilyl)ethane | Electrolyte | 1.0 | 73.6% |
| | | solution | | |

As shown in Table 3, the obtained residual capacity rates in Examples 1 to 3 were higher than those in Comparative Examples 1 and 2. The residual capacity rate in Comparative Example 2 in which the silane coupling agent was added to the electrolyte solution was lower than that in Comparative Example 1.

### Examples 4 to 9

An influence of the content of the silane coupling agent in the positive electrode was examined.

### Example 4

A battery for test was produced in the same manner as in Example 1 except that 1,2-bis(trimethoxysilyl)ethane was used as the silane coupling agent and it was added in a content of 0.05% by mass based on the positive-electrode active material.

### Example 5

A battery for test was produced in the same manner as in Example 1 except that 1,2-bis(trimethoxysilyl)ethane was used as the silane coupling agent, and it was added in a content of 0.1% by mass based on the positive-electrode active material.

### Example 6

A battery for test was produced in the same manner as in Example 1 except that 1,2-bis(trimethoxysilyl)ethane was used as the silane coupling agent, and it was added in a content of 0.5% by mass based on the positive-electrode active material.

### Example 7

A battery for test was produced in the same manner as in Example 1 except that 1,2-bis(trimethoxysilyl)ethane was used as the silane coupling agent, and it was added in a content of 2.0% by mass based on the positive-electrode active material.

### Example 8

A battery for test was produced in the same manner as in Example 1 except that 1,2-bis(trimethoxysilyl)hexane was used as the silane coupling agent, and it was added in a content of 0.05% by mass based on the positive-electrode active material.

### Example 9

A battery for test was produced in the same manner as in Example 1 except that 1,2-bis(trimethoxysilyl)hexane was used as the silane coupling agent, and it was added in a content of 0.5% by mass based on the positive-electrode active material.

[Measurement of Initial Charge and Discharge Efficiency, Increase in Thickness, and Residual Capacity Rate]

The initial charge and discharge efficiency, the increase in the battery thickness by the continuous charging at 60° C., and the residual capacity rate of the batteries in Examples 4 to 9 were measured, and the measurement results are shown in Table 4. Table 4 shows also the results in Example 1, Example 3, and Comparative Example 1.

| | | | Addition | Initial charge and | Increase | Residual |
|---|---|---|---|---|---|---|
| | | Object of | amount | discharge efficiency | in thickness | Capacity |
| | Silane coupling agent | addition | (% by mass) | (%) | (mm) | Rate |
| Example 4 | 1,2-bis (trimethoxysilyl)ethane | Positive | 0.05 | 90.2 | 0.37 | 81.7% |
| | | electrode | | | | |
| Example 5 | 1,2-bis (trimethoxysilyl)ethane | Positive | 0.1 | 90.2 | 0.36 | 80.2% |
| | | electrode | | | | |
| Example 6 | 1,2-bis (trimethoxysilyl)ethane | Positive | 0.5 | 90.0 | 0.37 | 80.6% |
| | | electrode | | | | |
| Example 1 | 1,2-bis (trimethoxysilyl)ethane | Positive | 1.0 | 89.3 | 0.33 | 81.8% |
| | | electrode | | | | |
| Example 7 | 1,2-bis (trimethoxysilyl)ethane | Positive | 2.0 | 89.5 | 0.41 | 82.4% |
| | | electrode | | | | |
| Example 8 | 1,2-bis (trimethoxysilyl)hexane | Positive | 0.05 | 89.8 | 0.54 | 82.1% |
| | | electrode | | | | |
| Example 9 | 1,2-bis (trimethoxysilyl)hexane | Positive | 0.5 | 89.3 | 0.42 | 82.8% |
| | | electrode | | | | |
| Example 3 | 1,2-bis (trimethoxysilyl)hexane | Positive | 1.0 | 89.6 | 0.46 | 78.6% |
| | | electrode | | | | |
| Comparative | — | — | 0 | 89.5 | 0.79 | 76.7% |
| Example 1 | | | | | | |

As shown in Table 4, even if the content of the silane coupling agent was varied within a range of 0.05 to 2.0% by mass, the increases in the battery thickness were smaller than that in Comparative Example 1 in which no silane coupling agent was used, and the gas generation caused by the continuous charging at a high temperature can be apparently suppressed. In addition, the obtained residual capacity rates were apparently high.

The difference in the initial charge and discharge efficiency could be scarcely observed between Examples 1, 3, and 4 to 9 in which the silane coupling agent was added and Comparative Example 1 in which no silane coupling agent was added. It was not confirmed, accordingly, that the surface-treatment of the positive-electrode active material with the silane coupling agent exert a bad influence on the initial charge and discharge efficiency.

What is claimed is:

1. A positive electrode for a nonaqueous electrolyte secondary battery comprising a positive-electrode active material,
wherein the positive-electrode active material has a surface-treated layer with a silane coupling agent represented by the following general formula (1):
X1-Y—X2 (1)
wherein Y is an alkylene group having 10 or less carbon atoms, and X1 and X2 are each represented by the general formula (2): 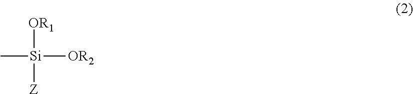
wherein Z is an alkyl group having 10 or less carbon atoms or OR₃, and R₁, R₂, and R₃ are each an alkyl group having 5 or less carbon atoms.

2. The positive electrode for a nonaqueous electrolyte secondary battery according to claim 1, wherein the silane coupling agent is included in a content within a range of 0.005 to 5% by mass based on the positive-electrode active material.

3. The positive electrode for a nonaqueous electrolyte secondary battery according to claim 1, wherein the silane coupling agent is included in a content within a range of 0.005 to 2% by mass based on the positive-electrode active material.

4. A method of producing the positive electrode according to claim 1 comprising the steps of:
kneading a mixture including a positive-electrode active material and the silane coupling agent in a solvent to prepare positive-electrode active material slurry; and
coating a surface of a positive electrode collector with the positive-electrode active material slurry to form a positive-electrode active material layer on the positive electrode collector.

5. A nonaqueous electrolyte secondary battery comprising the positive electrode according to claim 1, a negative electrode, and a nonaqueous electrolyte.
